(19) United States
(12) Patent Application Publication
(10) Pub. No.: US 2014/0308429 A1
(43) Pub. Date: Oct. 16, 2014

(54) Gourmet seafood salad

(71) Applicant: David Allen Ward, Baltimore, MD (US)

(72) Inventor: David Allen Ward, Baltimore, MD (US)

(73) Assignee: David Allen Ward, Baltimore, MD (US)

(21) Appl. No.: 13/986,246

(22) Filed: Apr. 16, 2013

(51) Int. Cl. A23L 1/325

(52) U.S. Cl. CPC A23L 1/3255
USPC 426/643

(57) ABSTRACT

Steamed shrimp, lump crabmeat, imitation crabmeat, combined with coleslaw mix, mayonnaise, Old Bay seasoning and sugar, which exhibits a unique texture blend is prepared by mixing these ingredients causing causing a protein preservative obtained mixture followed by refrigeration.

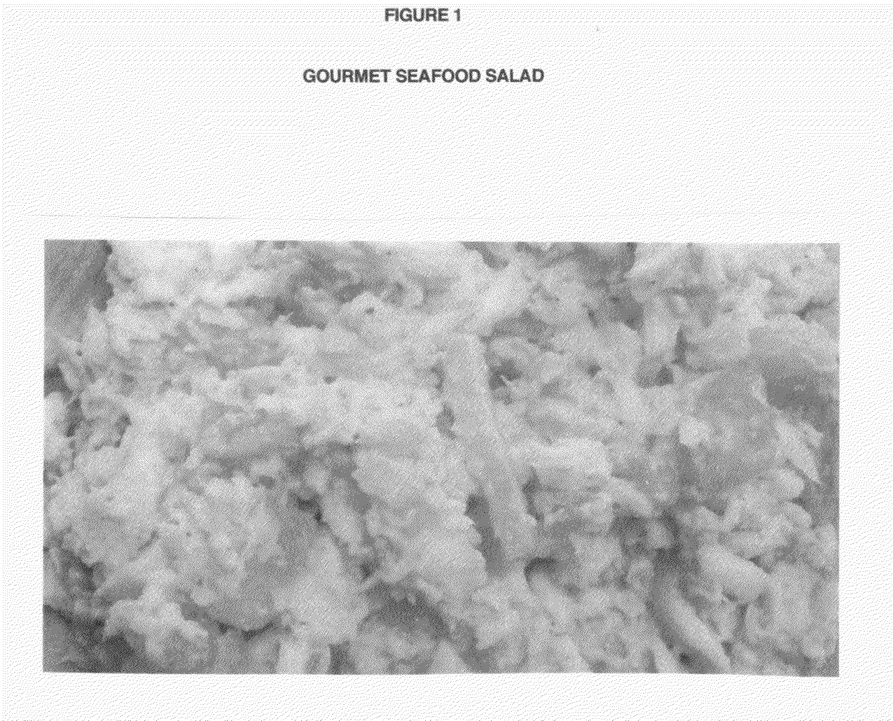

### INVENTOR'S DECLARATION

Gourmet Seafood Salad is the title of my invention, which I am now seeking a non-provisional Utility Patent for. On Apr. 27, 2012 I filed a provisional patent as required by law, to preserve and protect my invent with an early date filing. SEE Attached: Patent Pending receipt: U.S. patent application Ser. No. 61/687,576; confirmation #1354. Being a legally born citizen of The United States of America, I David A. Ward do hereby make the following statement in support of my request for a utility patent.

The following statement is my reason(s) of why I feel my invention qualifies as a patentable invention. This invention/creation is the end result based upon the fact it is a useful process, of a composition of matter/mixture and therefore has produced a new and useful improvement thereof. Until my invention there was no such composition. It's because of this fact, I set out to create my own mixture that produced a new and improved result.

This gourmet seafood salad is different in it's composition from start to finish. Beginning first with the process of the ingredient's mixture; secondly the composition of which changed the texture and taste of the product, caused by the overall composition invented/created through the expensive, time consuming development of myself David A. Ward the inventor. New and useful improvement (s) of this invention is 1) longer fresh and safe product consumption period instead of a 24 hour mandatory consume or throw it away policy. My invention has increased product consumption availability to a maximum of seven (7) days; 2) The process and composition of the ingredients achieves this without the use of artificial preservatives. The lack of artificial preservatives; the use of a unique composition of ingredients that acts a natural preservative in itself qualify this recipe as a patentable useful invention.

What I claim as my invention is a gourmet seafood salad:

1. The composition of ingredient mixture gives an extended product life to the end production. The uniqueness of the invented composition is that, the overall mixing process does not use any artificial preservatives. The composure of ingredient is 100% all natural, that also enhance the taste, extends the freshness and the eatable enjoyment of the production.
